(19) United States
(12) Patent Application Publication
(10) Pub. No.: US 2010/0257139 A1
(43) Pub. Date: Oct. 7, 2010

(54) Vehicle Data Security Method and System

(75) Inventors: Kerfegar K. Katrak, Fenton, MI (US); Steven D. Palazzolo, Clinton Township, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/692,959

(22) Filed: Mar. 29, 2007

(51) Int. Cl. G06F 12/16; G06F 17/30

(52) U.S. Cl. 707/640; 707/E17.005

(57) ABSTRACT

A method for validating variable data transmitted in a vehicle having at least one primary processor and at least one secondary processor includes generating a control copy and a redundant copy of the variable data in the at least one primary processor, providing the redundant copy of the variable data to the at least one secondary processor over a period of time, calculating one or more average values for the redundant copy of the variable data over the period of time in the at least one secondary processor, generating a transmittal message using the control copy of the data in the at least one primary processor during the period of time, providing the transmittal message to the at least one secondary processor, and comparing the transmittal message with the one or more calculated average values for the redundant copy of the variable data in the at least one secondary processor.

### TECHNICAL FIELD

The present invention generally relates to control systems found in automobiles and other vehicles, and more particularly relates to methods and systems for ensuring the security of data processed within a vehicle-based control system.

### BACKGROUND OF THE INVENTION

Modern automobiles and other vehicles may include sophisticated on-board computer systems that monitor the status and performance of various components of the vehicle (for example, the vehicle engine, transmission, brakes, suspension, and/or other components of the vehicle). Many of these computer systems may also adjust or control one or more operating parameters of the vehicle in response to operator instructions, road or weather conditions, operating status of the vehicle, and/or other factors.

Various types of microcontroller or microprocessor-based controllers found in many conventional vehicles include supervisory control modules (SCMs), engine control modules (ECMs), controllers for various vehicle components (for example, anti-lock brakes, electronically-controlled transmissions, or other components), among other modules. Such controllers are typically implemented with any one of numerous types of microprocessors, microcontrollers or other control devices that appropriately receive data from one or more sensors or other sources, process the data to create suitable output signals, and provide the output signals to control actuators, dashboard indicators and/or other data responders as appropriate. The various components of a vehicle-based control system typically inter-communicate with each other and/or with sensors, actuators, and other devices across any one of numerous types of serial and/or parallel data links. Today, data processing components within a vehicle are commonly interlinked by a data communications network such as a Controller Area Network (CAN), an example of which is described in ISO Standard 11898-1 (2003).

Because vehicles may now process relatively large amounts of digital data during operation, it can be an engineering challenge to ensure that the data processed is accurate and reliable. As digital data is stored, processed, consumed and/or shared between or within the various data processing components of a vehicle, for example, bit errors and the like can occur due to environmental factors, hardware faults, data transmission issues and other causes. As a result, various techniques have been developed to ensure the integrity of data processed and transferred within the vehicle. However, certain existing processes and systems for data security have potential limitations, are costly to design and/or implement, and/or are not customizable for different types of vehicles or systems.

It remains desirable to formulate systems and methods for ensuring data security within vehicle control systems, while potentially enhancing performance and/or reducing costs, and/or allowing for customization for different types of vehicles or systems. Other desirable features and characteristics will become apparent from the subsequent detailed description and the appended claims, taken in conjunction with the accompanying drawings and the foregoing technical field and background.

### SUMMARY OF THE INVENTION

A method is provided for validating variable data transmitted in a vehicle having at least one primary processor and at least one secondary processor. In one embodiment, and by way of example only, the method comprises the steps of generating a control copy and a redundant copy of the variable data in the at least one primary processor, providing the redundant copy of the variable data to the at least one secondary processor over a period of time, calculating one or more average values for the redundant copy of the variable data over the period of time in the at least one secondary processor, generating a transmittal message using the control copy of the data in the at least one primary processor during the period of time, providing the transmittal message to the at least one secondary processor, and comparing the transmittal message with the one or more calculated average values for the redundant copy of the variable data in the at least one secondary processor.

In another embodiment, and by way of example only, the variable data includes at least a yaw variable, a lateral acceleration variable, and a longitudinal acceleration variable, for transmittal in a system comprising at least one primary processor, at least one secondary processor, a first yaw sensor and a second yaw sensor for measuring values for the yaw variable, a first lateral acceleration sensor and a second lateral acceleration sensor for measuring values for the lateral acceleration variable, and a longitudinal acceleration sensor for measuring values for the longitudinal acceleration variable, and the method comprises generating a control copy of values for the first yaw sensor in the at least one primary processor, generating a control copy of values for the second yaw sensor in the at least one primary processor, generating a control copy of values for the first lateral acceleration sensor in the at least one primary processor, generating a control copy of values for the second lateral acceleration sensor in the at least one primary processor, generating a control copy of values for the longitudinal acceleration sensor in the at least one primary processor, generating a redundant copy of the values for the first yaw sensor in the at least one primary processor, generating a redundant copy of the values for the first lateral acceleration sensor in the at least one primary processor, generating a redundant copy of the values for the longitudinal acceleration sensor in the at least one primary processor, providing the redundant copies of the values for the first yaw sensor, the first lateral acceleration sensor, and the longitudinal acceleration sensor to the at least one secondary processor over a period of time, calculating one or more average values for the redundant copies of the values for the first yaw sensor, the first lateral acceleration sensor, and the longitudinal acceleration sensor over the period of time in the at least one secondary processor, comparing the control copy of the values for the first yaw sensor with the control copy of the values for the second yaw sensor, comparing the control copy of the values for the first lateral acceleration sensor with the control copy of the values for the second lateral acceleration sensor, generating a transmittal message using the control copies of the values for the first yaw sensor, the first lateral acceleration sensor, and the longitudinal acceleration sensor in the at least one primary processor during the period of time, providing the transmittal message to the at least one secondary processor, and comparing the transmittal message with the one or more calculated average values for the redundant copies of the values for the first yaw sensor, the first lateral acceleration sensor, and the longitudinal acceleration sensor in the at least one secondary processor.

An apparatus is provided for validating variable data transmitted in a vehicle. In one embodiment, and by way of example only, the apparatus comprises at least one primary processor and at least one secondary processor. The at least one primary processor is configured to generate a control copy and a redundant copy of the variable data, and to generate a transmittal message using the control copy of the data during a period of time. The at least one secondary processor is configured to receive the redundant copy of the variable data from the at least one primary processor over the period of time, to receive the transmittal message from the at least one primary processor, to calculate one or more average values for the redundant copy of the variable data over the period of time, and to compare the transmittal message with the one or more calculated average values for the redundant copy of the variable data.

### DESCRIPTION OF THE DRAWINGS

The present invention will hereinafter be described in conjunction with the following drawing figures, wherein like numerals denote like elements, and

FIG. 1 depicts an embodiment of a control system for processing and/or transmitting data and/or messages in a vehicle;

FIG. 2 depicts an embodiment of a process for securing data and/or associated messages transmitted in a vehicle, which can be implemented in connection with the control system of FIG. 1; and

FIG. 3 depicts an alternative embodiment of a control system for implementation of the process of FIG. 2.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

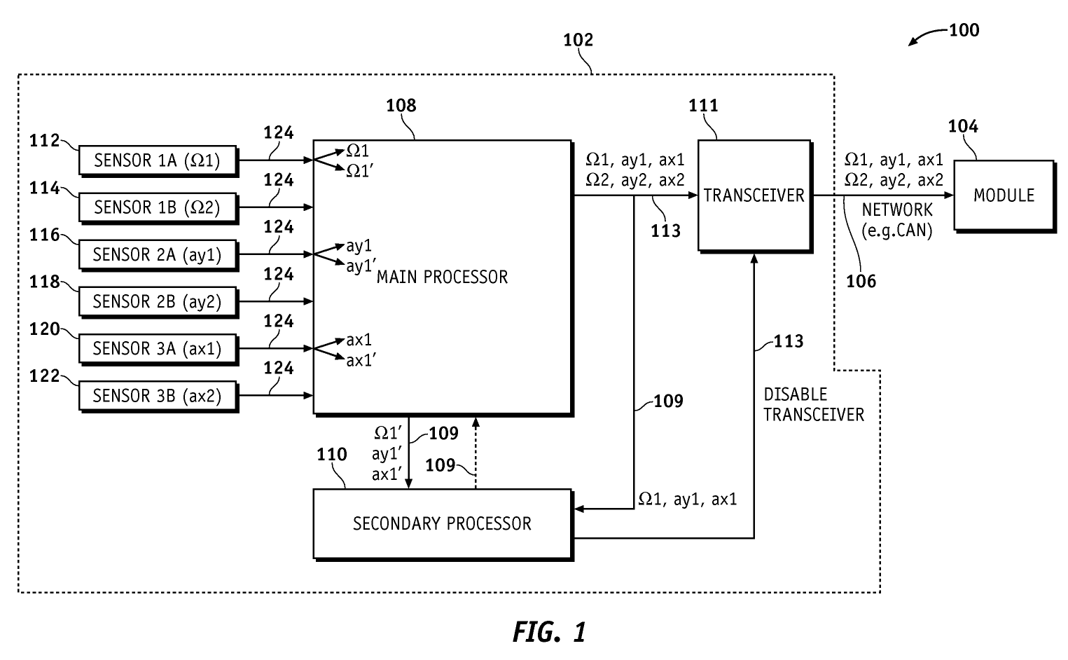

According to various exemplary embodiments, various methods and systems are presented for ensuring the integrity, security and/or reliability of data obtained, transmitted and/or processed by a control system. With reference to the FIG. 1, an exemplary control system 100 suitably includes any number of modules 102, 104 that exchange data via a data link 106. In various embodiments, data link 106 is a Controller Area Network (CAN) or other data network connection. Modules 102, 104 may be any one of numerous types of systems or devices having any one of numerous types of data processing hardware, such as any one of numerous types of microprocessors or microcontrollers.

Preferably one or more modules 102 suitably include any number of redundant processors, such as a main processor 108 and a secondary processor 110, and a transceiver 111. The main processor 108 and the secondary processor 110 are preferably interconnected by a conventional data connection 109 as appropriate. In various embodiments, connection 109 is a UART or other internal connection (e.g. a bus connection) within module 102. The processors 108 and/or 110 may be further configured to communicate with any number of sensors 112-122, actuators, indicators or other components as appropriate. Such connections may be provided over any type of serial, parallel, wireless or other data communication medium such as a Serial Peripheral Interface (SPI) connection or the like.

The sensors 112-122 preferably include various sensors such as primary and redundant sensors for a first variable, namely sensors 112 and 114 (respectively), primary and redundant sensors for a second variable, namely sensors 116 and 118 (respectively), and/or primary and redundant sensors for a third variable, namely sensors 120 and 122 (respectively). In the preferred embodiment depicted in FIG. 1, these sensors include primary and redundant yaw sensors 112 and 114 (respectively), primary and redundant lateral acceleration sensors 116 and 118 (respectively), and primary and redundant longitudinal acceleration sensors 120 and 122 (respectively). It will be appreciated that in certain embodiments some variables may only have one sensor, while any number of other variables may have two or more sensors. It will also be appreciated that the number and/or particular combination of variables and/or sensors may differ in various embodiments. Moreover, although this description emphasizes inertial sensors for purposes of illustration, similar concepts could be applied to various other types of sensors, actuators, indicators or other devices that are capable of transmitting or receiving data.

In the embodiment of FIG. 1, sensor data from the primary yaw sensor 112, the redundant yaw sensor 114, the primary lateral acceleration sensor 116, the redundant lateral acceleration sensor 118, the primary longitudinal acceleration sensor 120, and the redundant longitudinal acceleration sensor 122 are provided to the main processor 108 via one or more serial connections 124. However, it will be appreciated that various combinations of data values from some or all of these sources and/or other sources can be provided to the main processor 108 using any one of numerous different types of connections or other devices.

As shown in FIG. 1, the main processor 108 and the secondary processor 110 are interconnected via the data connection 109, and one or more of the processors (preferably both the main processor 108 and the secondary processor 110) communicate with the transceiver 111 via one or more transceiver links 113. For example, the main processor 108 is configured to generate a transmittal message and supply the transmittal message to the transceiver 111 via one or more of the transceiver links 113. Meanwhile, at least the secondary processor 110 (and preferably also the main processor 108) is configured to perform one or more checks on the transmittal message, and/or underlying data and/or operations pertaining thereto, and to either disable the transceiver 111 and/or send an appropriate indicator to the transceiver 111, via one or more of the transceiver links 113, in the event of any detected errors or other potential problems.

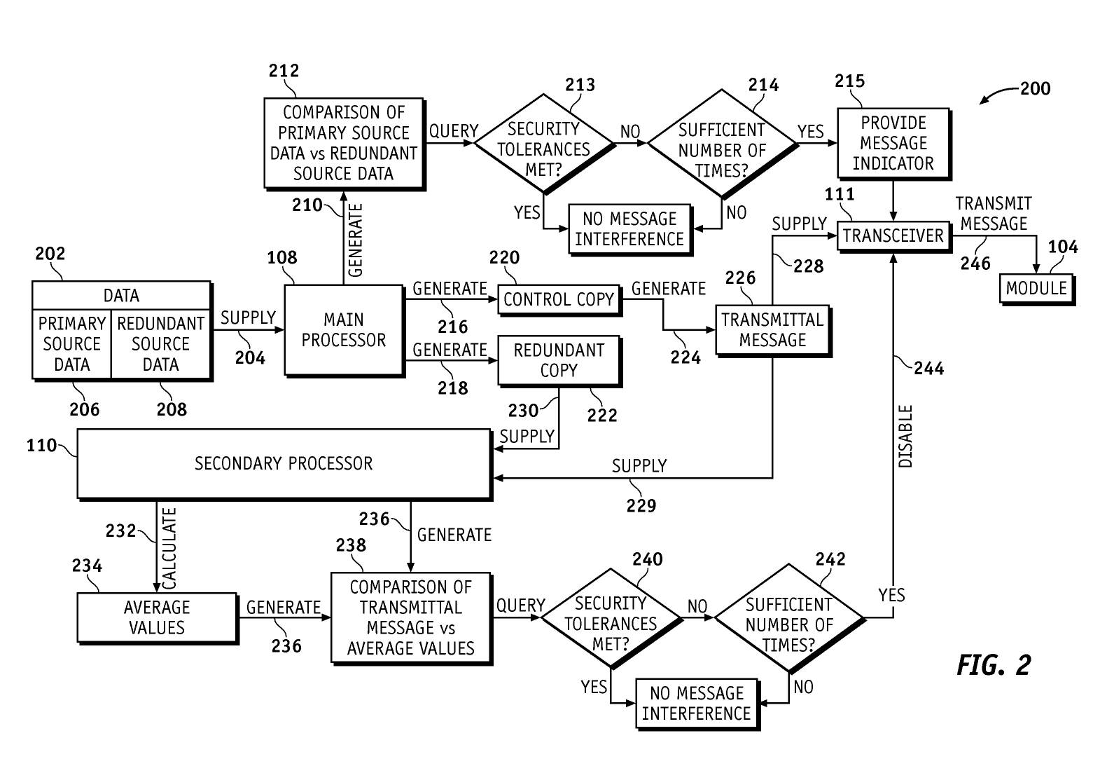

Turning now to FIG. 2, a flowchart is depicted of an exemplary embodiment of a process 200 for securing data 202 and/or associated transmittal messages 226 transmitted across the data link 106. Before proceeding further, it is noted that preferably the steps of the process 200 are continuously performed during operation of a vehicle, beginning with the first step 204, with certain steps performed more quickly and repeated more often than others, as described below.

First, data 202 is supplied to the main processor 108 in step 204. It will be appreciated that the data 202 can be supplied to the main processor 108 by means of any one of a number of different mechanisms, for example from the sensors 112-122 through the serial connections 124 as set forth in FIG. 1 above, and/or via any one of numerous other different types of mechanisms. Preferably, the data 202 provided to the main processor 108 in step 204 includes at least primary source data 206 obtained from one or more primary sources (such as the primary yaw sensor 112, the primary lateral acceleration sensor 116, and the primary longitudinal acceleration sensor 120), along with redundant source data 208 obtained from one or more redundant sources (such as the redundant yaw sensor 114, the redundant lateral acceleration sensor 118, and the redundant longitudinal acceleration sensor 122).

As alluded to above, new data 202 is preferably continuously supplied to the main processor 108 during operation of the vehicle. Accordingly, step 204 is preferably continuously performed in the process 200 as new data 202 becomes available. In turn, various other subsequent steps of the process 200 are also preferably continuously performed following each iteration of step 204, in which new data 202 is supplied to the main processor 108.

In step 210, the main processor 108 analyzes the data 202 and generates a comparison 212 between the primary source data 206 and the redundant source data 208. Then, in step 213, the main processor 108 performs a query as to whether the comparison 212 has met applicable security tolerances. Preferably, in steps 210 and 213 the main processor 108 subtracts various primary source data 206 values and various redundant source data 208 values from one another (for example, by subtracting a primary yaw sensor 112 value from a redundant yaw sensor 114 value, subtracting a primary lateral acceleration sensor 116 value from a redundant lateral acceleration sensor 118 value, and/or subtracting a primary longitudinal acceleration sensor 120 value from a redundant longitudinal acceleration sensor 122 value), and compares the results to one or more stored security tolerance values.

The stored security tolerance values preferably include predetermined security tolerance values for each of the variables in the data 202. The security tolerance values can be obtained via a manual or other information provided along with the sensors, and/or through experimentation, simulation and/or calibration involving the sensors, and may pertain to general and/or specific manufacturing tolerances, security metrics, and/or any of numerous other different types of tolerances. It will be appreciated that the security tolerance values can be obtained in any one of numerous different manners, and that the comparison and query of steps 210 and 213 can be conducted in any one of numerous different manners.

If it is determined in step 213 that the comparison 212 does not meet the security tolerances, then the process proceeds to step 214. In step 214, it is determined whether, through the various iterations of the process 200, there have been at least a predetermined number of times that the security tolerances have not been met. If it is determined in step 214 that the number of times the security tolerances have not been met is greater than or equal to the predetermined number, then, in step 215, the main processor 108 provides an indicator to the transceiver 111. The indicator preferably includes an indication that there may be an error in one or more of the data 202, a transmittal message 226, the control system 100, or the operations pertaining thereto. Most preferably, the indicator includes an indication of what type of potential error may have occurred. Alternatively, if it is determined either in step 213 that the security tolerances have been met, or in step 214 that the number of times the security tolerances have not been met is less than the predetermined number, then the main processor 108 does not interfere with the transceiver 111 or a transmittal message 226, and no indicator is provided.

It will be appreciated that steps 213-215 and/or other steps may vary in certain embodiments. For example, in certain embodiments, the main processor 108 may provide an indicator to the transceiver 111 directly after step 213 if it is determined in step 213 that the security tolerances have not been met in a particular iteration. Also, in various embodiments, the main processor 108 may disable the transceiver 111 in whole or in part based on certain detected errors. These and other steps may also include any one or more of numerous other variations in certain embodiments.

Meanwhile, in steps 216 and 218, the main processor 108 generates a control copy 220 and a redundant copy 222, respectively, of some or all of the data 202. Preferably, the control copy 220 generated in step 216 includes a copy of values from both the primary source data 206 and the redundant source data 208. For example, with reference to the above-described embodiment of the control system 100 from FIG. 1, preferably the control copy 220 includes a copy of values from each of the sensors 112-122, although it will be appreciated that the control copy 220 can instead include one or more copies of values from any number of these sensors, different sensors, and/or other sources, and/or combinations thereof.

In contrast, the redundant copy 222 generated in step 218 preferably only includes a copy of values from the primary source data 206. For example, with reference to the above-described embodiment of the control system 100 from FIG. 1, preferably the redundant copy 222 includes a copy of values from each of the primary sensors 112, 116, and 120, although it will be appreciated that the redundant copy 222 can instead include a copy of values from any number of these sensors, different sensors, and/or other sources, and/or combinations thereof.

The control copy 220 of the data 202 is used, in step 224, to generate the above-mentioned transmittal message 226. In step 228, the transmittal message 226 is then supplied to the transceiver 111 for transmittal to the module 104 along the data link 106, as described further below. Meanwhile, in step 229, the transmittal message 226 is supplied to the secondary processor 110 to conduct one or more checks on the data 202 and/or the transmittal message 226, also as described further below.

Preferably, the transmittal message 226 generated in step 224 includes values from both the primary source data 206 and the redundant source data 208. For example, with reference to the above-described embodiment of the control system 100 from FIG. 1, preferably the transmittal message 226 includes values from each of the sensors 112-122, although it will be appreciated that the transmittal message 226 can instead include values from any number of these sensor, other sensors, other sources, and/or combinations thereof. Regardless of their particular embodiments, steps 224, 228, and 229 preferably occur over a specific period of time during one iteration of the process 200.

Meanwhile, during this specific period of time, multiple iterations of step 230 are preferably performed, in which redundant copies 222 of the data 202 are supplied to the secondary processor 110. Preferably step 230 is conducted more quickly and more frequently than steps 228 and 229, as new data 202 is continuously supplied to the main processor 108 in step 204 and the corresponding new redundant copy 222 is continuously generated in step 218 multiple times during the generation of a single transmittal message 226 in step 224, all during the above-mentioned specific period of time during one iteration of the process 200. Accordingly, the secondary processor 110 receives multiple redundant copies 222 of data 202 through multiple iterations of step 230 for each transmittal message 226 that the secondary processor 110 receives through one iteration of step 229.

Next, in step 232, the secondary processor 110 calculates one or more average values 234 from the redundant copies 222 of the data 202, preferably including one or more arithmetic means, rolling averages, and/or other average values of the variables from the redundant copies 222 of the primary source data 206, calculated over the same above-referenced specific period of time. For example, in the above-described embodiment of the control system 100, the average values 234 calculated in step 232 preferably include average values calculated from the redundant copies 222 of yaw values from the primary yaw sensor 112, average values calculated from the redundant copies 222 of lateral acceleration values from the primary lateral acceleration sensor 116, and average values calculated from the redundant copies 222 of longitudinal acceleration data values from the primary longitudinal acceleration sensor 120, all calculated over the same specific period of time in which the transmittal message 226 is generated in step 224 and supplied to the transceiver 111 and the secondary processor 110 in steps 228 and 229, respectively.

The calculation of such average values 234 in step 232 can provide for a particularly effective cross-check measure, in part because steps 224, 228, and 229 (in which the transmittal message 226 is generated and supplied to the transceiver 111 and the secondary processor 110) generally occur more slowly and less frequently than steps 204, 218, and 230 (in which the data 202 is supplied to the main processor 108, and the redundant copy 222 of the data 202 is generated and supplied to the secondary processor 110). As mentioned above, steps 204, 218, and 230 are preferably repeated multiple times during the specific period of time in which steps 224, 228, and 229 are preferably performed only a single time. Accordingly, the average values 234 calculated in step 232 provide particularly valuable information regarding any errors or other potential problems with the data 202, the transmittal message 226, the operation of the control system 100, and/or other potential errors or problems.

Next, in step 236, the secondary processor 110 compares the values from the transmittal message 226 with the average values 234, thereby generating a comparison 238 of the transmittal message 226 versus the average values 234. Then, in step 240, the secondary processor 110 performs a query as to whether the comparison 238 meets appropriate security tolerances. Preferably, in steps 236 and 240 the secondary processor 110 subtracts various values from the transmittal message 226 from various average values 234 pertaining to corresponding variables, and compares the results to one or more stored security tolerance values for each of the variables.

As mentioned above, the stored security tolerance values preferably include predetermined security tolerance values for each of the variables in the data 202. Also as mentioned above, the security tolerance values may be initially obtained via a manual or other information provided along with the sensors, and/or through experimentation, simulation, calibration, and/or any one of numerous different manners, and may pertain to general and/or specific manufacturing tolerances, security metrics, and/or any of numerous other different types of tolerances. It will similarly be appreciated that the comparison and query of steps 236 and 240 can be conducted in any one of a number of different manners.

If it is determined in step 240 that the comparison 238 does not meet the security tolerances, then the process proceeds to step 242. In step 242, it is determined whether, through the various iterations of the process 200, there have been at least a predetermined number of times that the security tolerances have not been met. If it is determined in step 242 that the number of times the security tolerances have not been met is greater than or equal to the predetermined number, then, in step 244, the secondary processor 110 disables at least the transmitting functions of the transceiver 111, at least with respect to the variables for which a potential error or other problem has been detected. Alternatively, if it is determined either in step 240 that the security tolerances have been met, or in step 242 that the number of times the security tolerances have not been met is less than the predetermined number, then the secondary processor 110 does not interfere with the transceiver 111 or the transmittal message 226.

Similar to steps 213-215 described above, it will be appreciated that steps 240-244 and/or other steps may vary in certain embodiments. For example, in certain embodiments, the secondary processor 110 may disable the transceiver 111 in whole or in part directly following step 240, if it is determined in step 240 that the security tolerances have not been met in a particular iteration. These and other steps may also include any one or more of numerous other variations in certain embodiments.

Next, in step 246, the transceiver 111 transmits the transmittal message 226 to the module 104, provided that the transceiver 111 has not been disabled, for example by the secondary processor 110 in step 244. The transmission of the transmittal message 226 in step 246 preferably also includes transmission of the indicator if one has been provided to the transceiver 111 by the main processor 108 in step 215. Also, if the transceiver 111 has been at least partially disabled by the secondary processor 110, the transceiver 111 will not transmit the transmittal message 226, at least in this iteration of the process 200 with respect the variables to which the detected error or other potential problem relates. Preferably, if the transceiver 111 has been disabled by the secondary processor 110, then the transceiver 111 will not transmit the transmittal message 226 until at least the underlying error or other potential problem which triggered the disabling of the transceiver 111 has been corrected.

It will be appreciated that the process 200 can also be implemented in connection with any one or more of numerous different other techniques for securing data and/or messages for transmission in a vehicle. For example, the main processor 108 and/or the secondary processor 110 may perform additional data security measures such as any one or more of numerous different types of cross checks, checksums, arithmetic logic unit tests, register tests, seed and key tests or other tests on common arithmetic logic unit functions or structures between both processors 108 and 110, and/or any one or more of numerous other different types of tests or other techniques.

It will similarly be appreciated that the module 104 that receives the transmittal message 226 in step 246 may include any one of numerous different types of modules, receivers, and/or other devices, and/or combinations thereof. It will also be appreciated, that, after the transmittal message 226 is transmitted to the module 104 in step 246, any one of numerous different checks and/or normalization procedures, and/or combinations thereof, can be utilized to test, safeguard, and/or implement the information provided in the transmittal message 226 and any accompanying indicators.

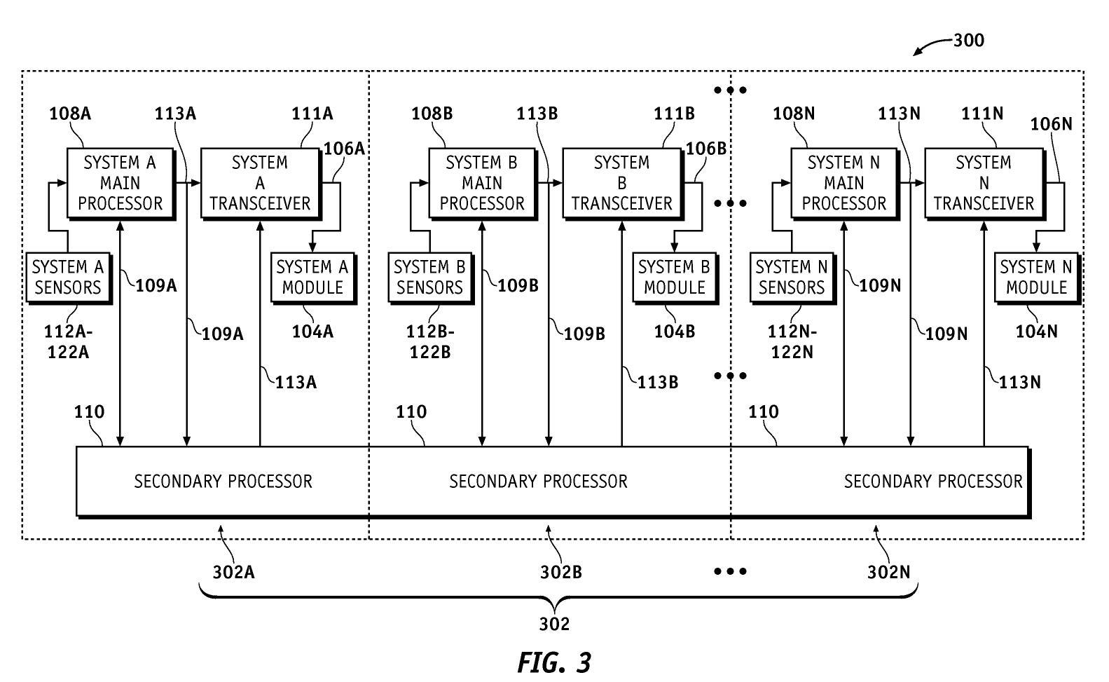

In addition, the process 200 can be implemented in connection with any one of numerous different types of systems. As set forth above, the process 200 is well suited for the embodiment of the control system 100 depicted in FIG. 1. However, the process 200 is also well suited for implementation in connection with various other different embodiments and types of systems, including the embodiment of system 300 depicted in FIG. 3, as described below.

Turning now to FIG. 3, an alternative preferred system 300 is depicted, for implementation of the process 200. As shown in FIG. 3, the system 300 includes a plurality of different functional based sub-systems 302 (for example, 302A, 302B, . . . , 302N). Preferably each sub-system 302 pertains to different vehicle functions and/or variables. For example, various sub-systems 302 may each individually pertain to one or more of the following functions: the vehicle's brakes, steering, steering and brakes combined, damper, roll control, and/or any one of numerous different vehicle functions and/or variables, and/or various combinations thereof.

As depicted in FIG. 3, each sub-system 302 preferably includes its own main processor (for example, main processor 108A in sub-system 302A, main processor 108B in sub-system 302B, and main processor 108N in sub-system 302N), but the sub-systems 302 share a common secondary processor 110. The secondary processor 110 is preferably connected to the main processors of the various sub-systems 302 via separate connections 109A, 109B, and 109N in sub-systems 302A, 302B, and 302N, respectively. In various embodiments, the sub-systems 302 may, but need not, each include their own sensors (for example, sensors 112A-122A, 112B-122B, and 112N-122N in sub-systems 302A, 302B, and 302N, respectively), transceivers (for example, transceivers 111A, 111B, and 111N in sub-systems 302A, 302B, and 302N, respectively), receiving modules 104 (for example, modules 104A, 104B, and 104N in sub-systems 302A, 302B, and 302N, respectively), data links (for example, data links 106A, 106B, and 106N in sub-systems 302A, 302B, and 302N, respectively), and/or other components. It will be appreciated that the system 300 may include any number of different sub-systems 302, with any number of possible configurations, each preferably including its own main processor 108 and sharing a common secondary processor 110.

Accordingly, in the embodiment of FIG. 3, preferably at least steps 204-230 of the process 200 of FIG. 2 are conducted by and/or in connection with different main processors 108 for each sub-system 302, and steps 232-244 are conducted by and/or in connection with a single, shared secondary processor 110. It will be appreciated that in certain embodiments certain sub-systems 302 may have more than one main processor 108, and/or may share one or more main processors 108 with one or more other sub-systems 302. It will also be appreciated that in certain embodiments the secondary processor 110 may include more than one processor, and/or that any number of sub-systems 302 may share a common secondary processor 110 in whole or in part while certain other sub-systems 302 may not.

By implementing the process 200 using the system 300 as described above in connection with the embodiment depicted in FIG. 3, one can customize different main processors 108 for different types of vehicles and/or vehicle systems. For example, the main processor 108 for a particular type of vehicle can include one or more customizable types of memory, processor speeds, and/or one or more of a number of other different types of attributes, based on the number and/or nature of sensors used in connection therewith, while using a common secondary processor 110 with each of the various main processors 108. This can also reduce costs of designing, manufacturing, maintaining, and/or installing the sensors 112-122, the main processors 108, and/or the secondary processor 110. In addition, this approach allows for various sensors to be developed and/or implemented as a family, with optimized main processors 108, based on security metrics and/or functional requirements for different types of vehicles, among various other potential advantages.

Using the techniques and apparatus described above, data security and integrity can be increased within an automotive or other data processing system while potentially increasing customization potential and/or reducing costs. As noted above, the particular techniques described herein may be modified in a wide array of practical embodiments, and/or may be deployed in any type of data collection, control, or other processing environment.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of validating variable data transmitted in a vehicle having at least one primary processor and at least one secondary processor, the method comprising the steps of:
generating a control copy and a redundant copy of the variable data in the at least one primary processor;
providing the redundant copy of the variable data to the at least one secondary processor over a period of time;
calculating one or more average values for the redundant copy of the variable data over the period of time in the at least one secondary processor;
generating a transmittal message using the control copy of the data in the at least one primary processor during the period of time;
providing the transmittal message to the at least one secondary processor; and
comparing the transmittal message with the one or more calculated average values for the redundant copy of the variable data in the at least one secondary processor.

2. The method of claim 1, wherein the vehicle also has a transceiver configured to transmit the transmittal message within the vehicle, and wherein the method further comprises the steps of:
determining whether the transmittal message and the one or more calculated average values for the redundant copy of the variable data meet a predetermined security tolerance; and
at least partially disabling the transceiver, if it is determined that the transmittal message and the one or more calculated average values for the redundant copy of the variable data do not meet the predetermined security tolerance.

3. The method of claim 2, wherein the variable data includes values from at least a first source of values and a second source of values for a particular variable, and wherein the method further comprises the steps of:
comparing the values from the first source of values and the second source of values for the particular variable;
determining whether the values from the first source of values and the second source of values meet a predetermined security tolerance; and
providing an indicator to the transceiver, if it is determined that the values from the first source of values and the second source of values do not meet the predetermined security tolerance.

4. The method of claim 1, wherein the step of calculating one or more average values for the redundant copy of the variable data over the period of time in the at least one secondary processor comprises:
calculating one or more arithmetic means for the values of the redundant copy of the variable data over the period of time in the at least one secondary processor.

5. The method of claim 1, wherein the step of calculating one or more average values for the redundant copy of the variable data over the period of time in the at least one secondary processor comprises:
calculating one or more rolling averages for the values of the redundant copy of the variable data over the period of time in the at least one secondary processor.

6. The method of claim 1, wherein the variable data includes values for a first yaw sensor, a second yaw sensor, a first lateral acceleration sensor, a second lateral acceleration sensor, and a longitudinal acceleration sensor, and wherein the step of generating a control copy and a redundant copy of the variable data in the at least one primary processor comprises:
generating a control copy of the values for the first yaw sensor in the at least one primary processor;
generating a control copy of the values for the second yaw sensor in the at least one primary processor;
generating a control copy of the values for the first lateral acceleration sensor in the at least one primary processor;
generating a control copy of the values for the second lateral acceleration sensor in the at least one primary processor;
generating a control copy of the values for the longitudinal acceleration sensor in the at least one primary processor;
generating a redundant copy of the values for the first yaw sensor in the at least one primary processor;
generating a redundant copy of the values for the first lateral acceleration sensor in the at least one primary processor; and
generating a redundant copy of the values for the longitudinal acceleration sensor in the at least one primary processor.

7. The method of claim 6, further comprising the steps of:
comparing the control copy of the values for the first yaw sensor with the control copy of the values for the second yaw sensor; and
comparing the control copy of the values for the first lateral acceleration sensor with the control copy of the values for the second lateral acceleration sensor.

8. The method of claim 7, wherein the variable data also includes values for a second longitudinal acceleration sensor, and wherein the method further comprises the steps of:
generating a control copy of the values for the second longitudinal acceleration sensor in the at least one primary processor; and
comparing the control copy of the values for the longitudinal acceleration sensor with the control copy of the values for the second longitudinal acceleration sensor.

9. The method of claim 1, wherein the vehicle includes a plurality of different functional based systems, and wherein:
the step of generating a control copy and a redundant copy of the variable data is conducted in different primary processors corresponding with different functional based systems;
the steps of providing the redundant copy of the variable data to the at least one secondary processor over a period of time and providing the transmittal message to the at least one secondary processor comprise providing such redundant copy and transmittal message to a single secondary processor; and
the steps of calculating one or more average values for the redundant copy of the variable data over the period of time and comparing the transmittal message with the one or more calculated average values for the redundant copy of the variable data are conducted in a single secondary processor.

10. A method of validating variable data including at least a yaw variable, a lateral acceleration variable, and a longitudinal acceleration variable, for transmittal in a system comprising at least one primary processor, at least one secondary processor, a first yaw sensor and a second yaw sensor for measuring values for the yaw variable, a first lateral acceleration sensor and a second lateral acceleration sensor for measuring values for the lateral acceleration variable, and a longitudinal acceleration sensor for measuring values for the longitudinal acceleration variable, the method comprising the steps of:
generating a control copy of values for the first yaw sensor in the at least one primary processor;
generating a control copy of values for the second yaw sensor in the at least one primary processor;
generating a control copy of values for the first lateral acceleration sensor in the at least one primary processor;
generating a control copy of values for the second lateral acceleration sensor in the at least one primary processor;
generating a control copy of values for the longitudinal acceleration sensor in the at least one primary processor;
generating a redundant copy of the values for the first yaw sensor in the at least one primary processor;
generating a redundant copy of the values for the first lateral acceleration sensor in the at least one primary processor;
generating a redundant copy of the values for the longitudinal acceleration sensor in the at least one primary processor;
providing the redundant copies of the values for the first yaw sensor, the first lateral acceleration sensor, and the longitudinal acceleration sensor to the at least one secondary processor over a period of time;
calculating one or more average values for the redundant copies of the values for the first yaw sensor, the first lateral acceleration sensor, and the longitudinal acceleration sensor over the period of time in the at least one secondary processor;
comparing the control copy of the values for the first yaw sensor with the control copy of the values for the second yaw sensor;
comparing the control copy of the values for the first lateral acceleration sensor with the control copy of the values for the second lateral acceleration sensor;
generating a transmittal message using the control copies of the values for the first yaw sensor, the first lateral acceleration sensor, and the longitudinal acceleration sensor in the at least one primary processor during the period of time;
providing the transmittal message to the at least one secondary processor; and
comparing the transmittal message with the one or more calculated average values for the redundant copies of the values for the first yaw sensor, the first lateral acceleration sensor, and the longitudinal acceleration sensor in the at least one secondary processor.

11. The method of claim 10, wherein the vehicle also has a transceiver configured to transmit the transmittal message within the vehicle, and wherein the method further comprises the steps of:
determining whether the transmittal message and the one or more calculated average values for the redundant copies meet a predetermined security tolerance; and
at least partially disabling the transceiver, if it is determined that the transmittal message and the one or more calculated average values for the redundant copies do not meet the predetermined security tolerance.

12. The method of claim 10, further comprising the steps of:
determining whether the control copies of the values for the first yaw sensor and the second yaw sensor meet a predetermined security tolerance;
determining whether the control copies of the values for the first lateral acceleration sensor and the second lateral acceleration sensor meet the predetermined security tolerance; and
providing an indicator to the transceiver, if it is determined that any of the control copies of the values for the first yaw sensor and the second yaw sensor, or the first lateral acceleration sensor and the second lateral acceleration sensor, do not meet the predetermined security tolerance.

13. The method of claim 10, wherein the variable data also includes values for a second longitudinal acceleration sensor, and wherein the method further comprises the steps of:
generating a control copy of the values for the second longitudinal acceleration sensor in the at least one primary processor;
comparing the control copy of the values for the longitudinal acceleration sensor with the control copy of the values for the second longitudinal acceleration sensor;
determining whether the control copies of the values for the longitudinal acceleration sensor and the second longitudinal acceleration sensor meet a predetermined security tolerance; and
providing an indicator to the transceiver, if it is determined that the control copies of the values for the longitudinal acceleration sensor and the second longitudinal acceleration sensor do not meet the predetermined security tolerance.

14. The method of claim 10, wherein the step of calculating one or more average values for the redundant copies of the values for the first yaw sensor, the first lateral acceleration sensor, and the longitudinal acceleration sensor over the period of time in the at least one secondary processor comprises:
calculating one or more arithmetic means for the values of the redundant copies of the values for the first yaw sensor, the first lateral acceleration sensor, and the longitudinal acceleration sensor over the period of time in the at least one secondary processor.

15. The method of claim 10, wherein the vehicle includes a plurality of different functional based systems, and wherein:
the steps of generating a control copy of values for the first yaw sensor, generating a control copy of values for the second yaw sensor, generating a control copy of values for the first lateral acceleration sensor, generating a control copy of values for the second lateral acceleration sensor, generating a control copy of values for the longitudinal acceleration sensor, generating a redundant copy of the values for the first yaw sensor, generating a redundant copy of the values for the first lateral acceleration sensor, and generating a redundant copy of the values for the longitudinal acceleration sensor are conducted in different primary processors corresponding with different functional based systems;
the steps of providing the redundant copies of the values for the first yaw sensor, the first lateral acceleration sensor, and the longitudinal acceleration sensor to the at least one secondary processor over a period of time and providing the transmittal message to the at least one secondary processor comprise providing such redundant copies and transmittal message to a single secondary processor; and
the steps of calculating one or more average values for the redundant copies of the values for the first yaw sensor, the first lateral acceleration sensor, and the longitudinal acceleration sensor over the period of time, and comparing the transmittal message with the one or more calculated average values for the redundant copies of the values for the first yaw sensor, the first lateral acceleration sensor, and the longitudinal acceleration sensor are conducted in a single secondary processor.

16. An apparatus for validating variable data transmitted in a vehicle, the apparatus comprising:
at least one primary processor configured to generate a control copy and a redundant copy of the variable data, and to generate a transmittal message using the control copy of the data during a period of time; and
at least one secondary processor configured to receive the redundant copy of the variable data from the at least one primary processor over the period of time, to receive the transmittal message from the at least one primary processor, to calculate one or more average values for the redundant copy of the variable data over the period of time, and to compare the transmittal message with the one or more calculated average values for the redundant copy of the variable data.

17. The apparatus of claim 16, wherein the vehicle also has a transceiver, and wherein the at least one secondary processor is further configured to determine whether the transmittal message and the one or more calculated average values for the redundant copy of the variable data meet a predetermined security tolerance, and to disable the transceiver if it is determined that the transmittal message and the one or more calculated average values for the redundant copy of the variable data do not meet the predetermined security tolerance.

18. The apparatus of claim 17, wherein the variable data includes at least values from a first source of values and a second source of values for a particular variable, and wherein the at least one primary processor or the at least one secondary processor is further configured to compare the values from the first source of values and the second source of values.

19. The apparatus of claim 16, wherein the vehicle includes a plurality of different functional based systems, and wherein:
the at least one primary processor comprises a plurality of different primary processors corresponding with the different functional based systems; and
the at least one secondary processor comprises a single processor.

20. The apparatus of claim 19, wherein each of the plurality of different primary processors are configured to receive variable data from a specified number of sensors, and have at least a processor speed or memory size that is customizable at least in part based on the predetermined number of sensors.
